(19) United States
(12) Patent Application Publication
(10) Pub. No.: US 2019/0324002 A1
(43) Pub. Date: Oct. 24, 2019

(54) PROTECTION DEVICE OF INTEGRATED COLUMN USED IN CAPILLARY LIQUID CHROMATOGRAPHY-ELECTROSPRAY IONIZATION-MASS SPECTROMETRY

(71) Applicants: Yufeng Shen, Richland, WA (US); Annie Shen, Richland, WA (US)

(72) Inventors: Yufeng Shen, Richland, WA (US); Annie Shen, Richland, WA (US)

(21) Appl. No.: 16/384,007

(22) Filed: Apr. 15, 2019

Related U.S. Application Data
(60) Provisional application No. 62/661,430, filed on Apr. 23, 2018.

(51) Int. Cl. G01N 30/60; G01N 30/72

(52) U.S. Cl. CPC G01N 30/6047; G01N 2030/027; G01N 30/7266; G01N 30/6095

(57) ABSTRACT

A device for protecting electrospray ionization (ESI) emitter tip made on a fused silica capillary nanoscale liquid chromatography (nanoLC) column for robust use of the nanoLC-ESI integrated column.

### RELATED APPLICATION

This application claims priority from U.S. provisional patent application No. 62/661,430, filed Apr. 23, 2018, which is hereby incorporated herein by reference in its entirety for all purposes.

### BACKGROUND OF THE INVENTION

This invention pertains to a novel device for protecting nanoscale liquid chromatography (nanoLC)-electrospray ionization (ESI) integrated columns.

Nanoscale liquid chromatography (nanoLC)-mass spectrometry (MS) is the most powerful tool in chemical and biological laboratories for analysis of complex mixtures of molecules, such as for proteomic analysis. Coupling of nanoLC and MS is completed through electrospray ionization (ESI) interface. The analytes ionized in the nanoLC mobile phases (typically acidic solvents) are sprayed into MS through an ESI emitter by application of a voltage. The ESI emitter can be made separately and connected on the nanoLC column outlet with a connector (e.g., a union) (such column is referred as separated column), or directly made on the nanoLC column outlet (such column is referred as integrated column). The integrated column provides high sample recovery and high separation efficiency, especially for fast and sensitive analysis. In contrast, a separated column produces more or less losses of sample and separation efficiency due to use of the column connector.

Currently, all integrated columns have been made with use of fused silica capillary tubes, although the manufacture methods can be significantly different. Fused silica capillary has advantages over other materials, including its chemical inertness to most analytes, mechanical strength needed for use of nanoLC columns under high or even ultrahigh pressures, electrical insulation for easy application of ESI voltage, and highly smooth inner surface for generation of high separation efficiency. However, the sharp tip pulled on a fused silica capillary tube for production of a sensitive ESI emitter is very brittle. Damaging the ESI emitter tip will destroy the ESI sensitivity and result in uselessness of a nanoLC-ESI integrated column, usually hundreds of dollars and even more than one thousand dollars per column. There is, therefore, a need for a device to protect the ESI emitter tip and thus the nanoLC-ESI integrated column. This protection device should allow for robust and convenient use of nanoLC-ESI integrated columns for achieving high-quality mass spectrometry datasets in routine nanoLC-MS experiments without need of extreme carefulness.

### SUMMARY OF THE INVENSTION

The protection device of a nanoLC-ESI integrated column of the invention is a tubes-sliding device. This protection device allows protecting a nanoLC-ESI integrated column during its transportation, setup, and use. The protection device comprises of a nanoLC column protection tube that covers a fused silica capillary nanoLC column, a protection sleeve tube that protects the ESI emitter tip manufactured on the fused silica capillary nanoLC column, and a sliding tube that provides a desirable friction needed for pulling/pushing. As illustrated in FIGS. 1 and 2, simply pulling/pushing the protection sleeve tube along the nanoLC column protection tube makes the nanoLC-ESI integrated column ESI emitter tip covered or exposed for protection or use of the nanoLC-ESI integrated column.

### BRIEF DESCRIPTION OF THE DRAWINGS

FIG. 1 is a schematic diagram showing the protection device in the protection state of a fused silica capillary nanoLC-ESI integrated column.

FIG. 2 is a schematic diagram showing the protection device in the use state of a fused silica capillary nanoLC-ESI integrated column.

FIG. 3A is a plan view of the protection device illustrated in FIG. 1.

FIG. 3B is a plan view of the protection device illustrated in FIG. 2.

### DETAILED DESCRIPTION

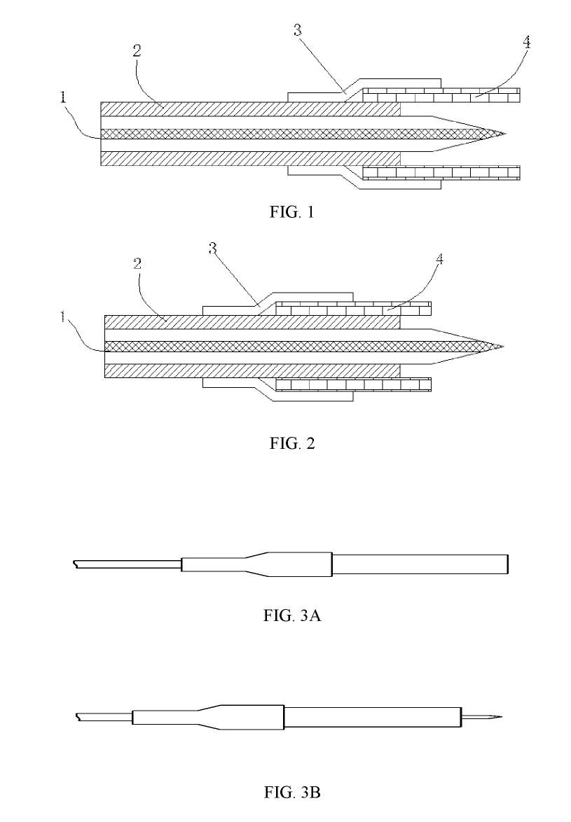

An embodiment of a fused silica capillary nanoLC-ESI integrated column protection device of the present invention will be described with reference to FIGS. 1, 2, 3A, and 3B.

As illustrated in FIG. 1, The protection device comprises of a protection tube 2 to protect a fused silica capillary nanoLC column 1, a protection sleeve tube 4 to protect an ESI emitter tip manufactured on the fused silica capillary nanoLC column 1, and a sliding tube 3 that provides friction needed for sliding. The nanoLC column protection tube 2 has an inner diameter (ID) of 0.015″ (−380 μm) to match the outer diameter (OD) of the fused silica capillary nanoLC column 1 (−365 μm OD) and an OD of 1/32″ that can be easily fitted by using conventional nanoLC fittings. The sliding tube 3 is a heat shrink tube that provides a desirable friction for sliding the protection sleeve tube 4 along the nanoLC column protection tube 2 by pushing/pulling. The protection sleeve tube 4 is a 1/32″ ID× 1/16″ OD PEEK tube with a length of 4 cm for protection of the ESI emitter of the nanoLC-ESI integrated column.

For the nanoLC column protection tube 2, a plastic Nylon tube or PEEK tube with 1/32″ OD is selected. This 1/32″ OD Nylon or PEEK tube, in addition to being easily fitted, is flexible and favors for convenient operation of the protected nanoLC-ESI integrated column during nanoLC-MS experiments. For the sliding tube 3, a 1/16″ ID heat shrink tube with a shrink ratio of 2:1 is selected. After heated and cooled, this shrink tube bonds the protection sleeve tube 4 ( 1/16″ OD) tightly, while allows the protection sleeve tube 4 ( 1/32″ OD) to be movable along the nanoLC column protection tube 2. For the protection sleeve tube 4, a relatively rigid 1/16″ OD PEEK tube is selected to avoid damage of the ESI emitter due to abrupt bend of the protection sleeve tube.

The protection device is made as follows: insert the nanoLC-ESI integrated column 1 into the nanoLC column protection tube 2 until there is 1-5 mm from the integrated column ESI emitter tip exposed; insert the integrated column 1 and its protection tube 2 into the ESI protection sleeve tube 4 and let the protection sleeve tube 4 fully cover the ESI tip; cover the nanoLC column protection tube 2 and the ESI protection sleeve tube 4 with the sliding tube 3 (the covered end of the protection sleeve tube 4 is in about middle of the sliding tube 3); use an electric heat gun to heat the sliding tube 3 for 1-2 minutes to make it tightly wrap the ESI protection sleeve tube 4 and the nanoLC column protection tube 2; after completely cooled, move the sliding tube 3/the ESI protection sleeve tube 4 along the nanoLC column protection tube 2 to make sure the sliding friction suitable for ease use. FIGS. 3A and 3B show plan views of the protection device made by using the materials and method described above in the state of protection (FIG. 3A) and in the state of use (FIG. 3B) of a nanoLC-ESI integrated column.

When a nanoLC-ESI integrated column is transported, stored, and installed for nanoLC-MS experiments, the integrated column protection device must be in the state of protection, as illustrated in FIGS. 1 and 3A. After installation, holding the nanoLC column protection tube 2 and slowly pulling the sliding tube 3/the protection sleeve tube 4 towards the column inlet end makes the ESI emitter tip exposed (i.e., change the protection device state from FIGS. 1 and 3A to FIGS. 2 and 3B). The exposed ESI emitter tip is aligned to the mass spectrometry entrance capillary to make it ready for nanoLC-MS experiments. During nanoLC-MS experiments, the ESI emitter tip keeps exposed (i.e., in the state of use). When experiments are finished and the column needs to be removed, the protection device must be restored to the protection state by holding the nanoLC column protection tube 2 and slowly pushing the sliding tube 3/the protection sleeve tube 4 towards the ESI emitter tip until the emitter tip is totally covered by the protection sleeve tube 4.

Although the present invention has been shown with respect to the above described embodiment, various changes, additions, and omissions in the form and detail thereof may be made therein without departing from the spirit and scope of the invention.

### REFERENCES CITED

[1] F. Xie, R. D. Smith, Y. Shen. Advanced proteomic liquid chromatography (Review). J. Chromatogr. 1261, 78-90 (2012).
[2] Y. Shen, R. Zhao, S. J. Berger, G. A. Anderson, N. Rodriguez, R. D. Smith. High-Efficiency Nanoscale Liquid Chromatography Coupled On-line With Mass Spectrometry Through Nanoelectrospray Ionization. Anal. Chem. 74, 4235-4249 (2002).
[3] Y. Shen, R. D. Smith, K. K. Unger, D. Kumar, D. Lubda. Ultrahigh-Throughput Proteomics Using RPLC-ESI MS/MS. Anal. Chem. 77, 6692-6701 (2005).
[4] Y. Shen, E. F. Strittmatter, R. Zhang, T. O. Metz, R. J. Moore, F. Li, H. R. Udseth, R. D. Smith, K. K. Unger, D. Kumar, D. Lubda. Making Broad Proteome Protein Measurements in 1-5 min Using High-Speed RPLC Separations and High Accuracy Mass Measurements. Anal. Chem. 77, 7763-7773 (2005).
[5] R. Zhao, S.-J. Ding, Y. Shen, D. G. Camp II, E. A. Livesay, H. Udseth, R. D. Smith. Automated metal-free multiple-column nanoLC improved phosphopeptide analysis sensitivity and throughput. J. Chromatogr. B. 877, 663-670 (2009).
[6] F. Zhou, Y, L, S. L. Ficarro, J. T. Webber, J. A. Marto. Nanoflow low pressure high peak capacity single dimension LC-MS/MS platform for high-throughput, in-depth analysis of mammalian proteomes. Anal. Chem. 84, 5133-5139 (2012).
[7] G. A. Valaskovic, 2001, Evaporative packing of capillary columns, U.S. Pat. No. 6,190,559, B1.
[8] J. A. Marto, 2010, Chromatographic columns with integrated electrospray emitters, US 2010/0193683 A1.
[9] P. Myers, 1999, Use of porous beads as a tip for nano-electrospray, WO 99/58252.

We claim:

1. A nanoLC-ESI integrated column protection device comprises a protection sleeve tube to protect the integrated nanoLC column ESI emitter, a protection tube to protect the integrated nanoLC column, and a sliding tube to provide sliding friction for pulling/pushing said protection sleeve tube.

2. The nanoLC-ESI integrated column protection device of claim 1, wherein said protection sleeve tube has a length ranging from 1 mm to full length of the integrated column.

3. The nanoLC-ESI integrated column protection device of claim 2, wherein said protection sleeve tube is made of plastic, metal, rubber, or other materials.

4. The nanoLC-ESI integrated column protection device of claim 3, wherein said protection sleeve tube is in the shape of round, square, or others.

5. The nanoLC-EST integrated column protection device of claim 4, wherein said protection sleeve tube in the shape of round has an inner diameter ranging from 0.01 mm to 3 mm and an outside diameter ranging from 0.01 mm to 30 mm.

6. The nanoLC-ESI integrated column protection device of claim 4, wherein said protection sleeve tube in the shape of square and others has an inside dimension ranging from 0.01 mm to 3 mm and an outside dimension ranging from 0.01 mm to 30 mm.

7. The nanoLC-ESI integrated column protection device of claim 1, wherein said protection tube has a length ranging from zero to full length of the nanoLC column. (Said protection tube length of zero means that said protection sleeve tube slides directly along the fused silica capillary nanoLC column.)

8. The nanoLC-ESI integrated column protection device of claim 7, wherein said protection tube to protect the nanoLC column is made of plastic materials.

9. The nanoLC-ESI integrated column protection device of claim 8, wherein said protection tube is in the shape of round, square, or others.

10. The nanoLC-ESI integrated column protection device of claim 9, wherein said protection tube in the shape of round has an inner diameter ranging from 0.01 mm to 3 mm and an outside diameter ranging from 0.01 mm to 30 mm.

11. The nanoLC-ESI integrated column protection device of claim 9, wherein said protection tube in the shape of square or others has an inside dimension ranging from 0.01 mm to 3 mm and an outside dimension ranging from 0.01 mm to 30 mm.

12. The nanoLC-ESI integrated column protection device of claim 1, wherein said sliding tube to provide sliding friction for pulling/pushing said protection sleeve tube is made of heat shrink with a shrink ratio from 2:1 to 6:1 or other rubber materials.

13. The nanoLC-ESI integrated column protection device of claim 12, wherein said sliding tube can be either glued or not glued heat shrink tube or other rubber tube.

14. The nanoLC-ESI integrated column protection device of claim 13, wherein said sliding tube can be a single layer of heat shrink tube or other rubber tube or multiple layers of heat shrink tubes and/or other rubber tubes for adjustment of friction magnitude for easy operation of the protection device.

15. The nanoLC-ESI integrated column protection device of claim 14, wherein said sliding tube has a length ranging from 1 mm to full length of the nanoLC column.

16. The nanoLC-ESI integrated column protection device of claim 15, wherein said sliding tube has a shape of round, square, or others.

17. The nanoLC-ESI integrated column protection device of claim 16, wherein said sliding tube in round or other shapes has an inner dimension ranging from 0.01 mm to 10 mm and an outside dimension ranging from 0.01 mm to 30 mm.

18. The nanoLC-ESI integrated column protection device of claim 12, wherein said sliding tube providing sliding friction can be used inside or outside said protection sleeve tube.
